(19) United States
(12) Patent Application Publication
(10) Pub. No.: US 2013/0115587 A1
(43) Pub. Date: May 9, 2013

(54) EMERGENCY COMMAND SYSTEM AND METHOD

(71) Applicants: SHIH-CHENG WANG, Tu-Cheng (TW); YI-WEN CAI, Tu-Cheng (TW)

(72) Inventors: SHIH-CHENG WANG, Tu-Cheng (TW); YI-WEN CAI, Tu-Cheng (TW)

(73) Assignee: HON HAI PRECISION INDUSTRY CO., LTD., Tu-Cheng (TW)

(21) Appl. No.: 13/288,115

(22) Filed: Nov. 3, 2011

(51) Int. Cl. G09B 25/00

(52) U.S. Cl. 434/365

(57) ABSTRACT

An emergency command system is provided. The emergency command system selectively operated in a real time monitoring mode, a forecast mode, and a strategy inferring mode includes an input interface unit, a scene information unit, an emergency status providing unit, a strategy inferring unit, an output interface unit, and a commanding unit. The emergency status providing unit receives an alarm signal corresponding to an emergency, and produces scene simulation data according to the alarm signal and a set of scene information in the scene information unit corresponding to the emergency. The strategy inferring unit produces a strategy inference diagram according to the scene simulation data and/or strategy data input through the input interface unit, thereby displaying through the output interface unit. The commanding unit transmits command signals produced according to the strategy data to terminal devices. The disclosure further provides an emergency command method.

### BACKGROUND

1. Technical Field

The present disclosure relates to an emergency command system and an emergency command method, and particularly to an emergency command system and an emergency command method for assisting an emergency responder.

2. Description of Related Art

During an emergency such as a fire in a populated building, an emergency responder may take control of the scene of the emergency. However, in a conventional emergency system, the information of the scene of the emergency provided to the emergency responder may be inadequate for the responder to use in making decisions regarding response to the emergency. In addition, the effects of the emergency responder's decisions cannot be predicted in advance and recorded in real time. Consequently, the efficacy of the emergency response may be greatly affected.

What is needed, therefore, is an emergency command system capable of overcoming the limitation described.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of an emergency command system of the present disclosure.

FIG. 2 is a schematic view of an embodiment of the emergency guiding system of FIG. 1 in real time monitoring mode.

FIG. 3 is a schematic view of an embodiment of the emergency guiding system of FIG. 1 in forecast mode.

FIG. 4A is a schematic view of an embodiment of the emergency guiding system of FIG. 1 in strategy inferring mode to show predetermined guiding schemes.

FIG. 4B is a schematic view of an embodiment of the emergency guiding system of FIG. 1 in strategy inferring mode to edit a predetermined guiding scheme.

FIG. 4C is a schematic view of an embodiment of the emergency guiding system of FIG. 1 in strategy inferring mode to simulate the effect of a strategy.

FIG. 4D is a schematic view of an embodiment of the emergency guiding system of FIG. 1 in strategy inferring mode to show a warning message.

FIG. 5 is a block diagram of another embodiment of an emergency command system of the present disclosure.

FIG. 6 is a flowchart of an embodiment of an emergency command method of the present disclosure.

FIG. 7A/7B is a flowchart of another embodiment of an emergency command method of the present disclosure.

### DETAILED DESCRIPTION

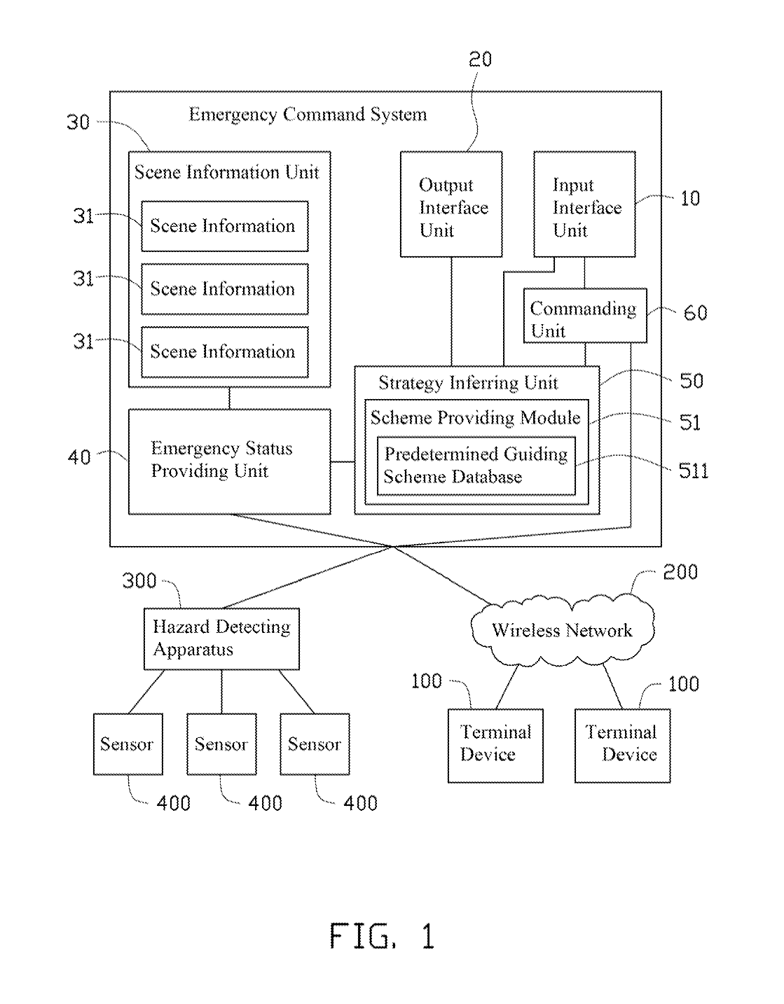

FIG. 1 is a block diagram of an embodiment of an emergency command system of the present disclosure. As shown in FIG. 1, an emergency command system includes an input interface unit 10, an output interface unit 20, a scene information unit 30, an emergency status providing unit 40, a strategy inferring unit 50, and a commanding unit 60. In the illustrated embodiment, the emergency command system is applied in response to a fire emergency. In other embodiments, the emergency command system can be applied to other types of emergencies such as an earthquake, illegal entry, or other potentially dangerous situations. In the illustrated embodiment, the emergency command system is installed in an electronic device such as personal computer or notebook computer. In addition, the emergency command system communicates with terminal devices 100 through a wireless network 200 which is implemented according to a telecommunication standard such as Wi-Fi, Bluetooth, and GSM (Global System for Mobile Communications). The terminal devices 100 are portable devices such as tablet computers or smart phones. In other embodiments, the emergency command system can be installed in other types of electronic device such as server or portable device. In addition, the emergency command system can communicate with terminal devices 100 through other types of wireless network or wired network such as local area network. The terminal devices 100 can be other types of portable devices such as notebook computers.

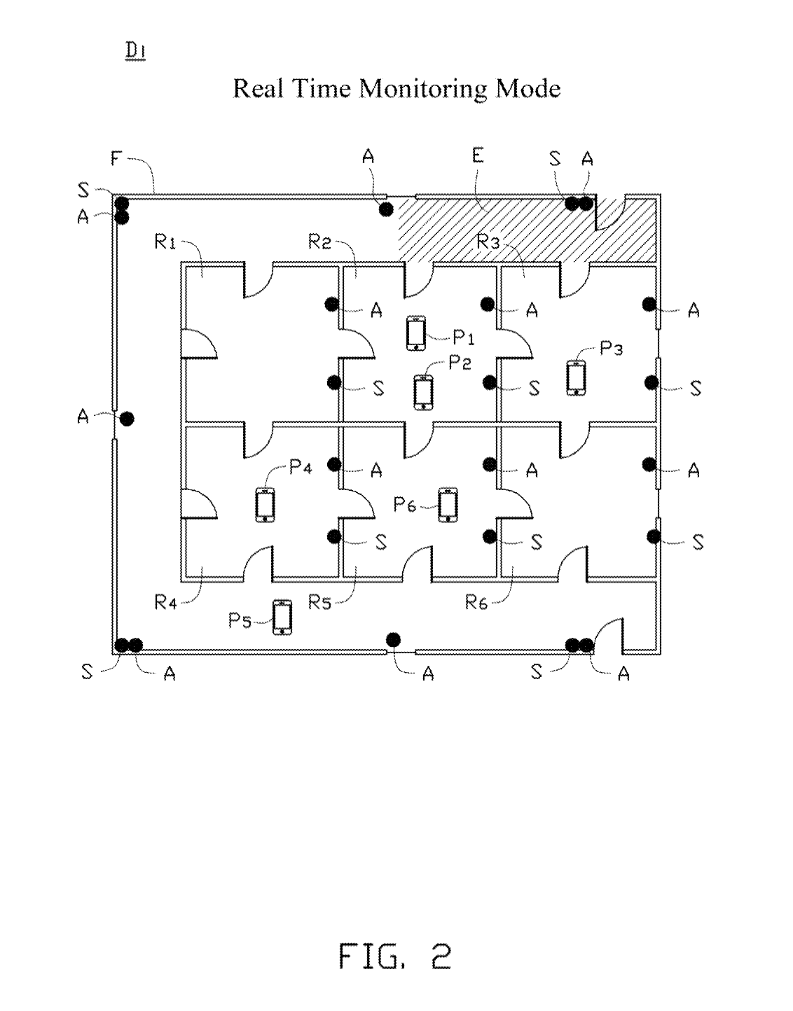

The input interface unit 10 is a human machine interface (HMI) such as a keyboard, a mouse, or a touch panel for inputting data. The output interface unit 20 is a human machine interface such as a display panel for outputting data to a device. The scene information unit 30 includes a plurality of sets of scene information 31. In the illustrated embodiment, each set of scene information 31 includes a fire fighting apparatus information Iₐ. (not shown) including the information of the fire fighting apparatuses at the scene of an emergency such as the type, the location, and other features of the fire fighting apparatuses. The emergency status providing unit 40 receives an alarm signal Sₐ (not shown) corresponding to an emergency E (see FIG. 2), such as a fire, from a hazard detecting apparatus 300 which comprises a plurality of sensors 400 such as smoke and/or heat detectors, thereby producing scene simulation data Dₛ (not shown) corresponding to the alarm signal Sₐ in real time. In the illustrated embodiment, the scene simulation data Dₛ is produced in real time according to status information Iₛ (not shown) of the actuated sensors 400 in the alarm signal Sₐ, the set of scene information 31 corresponding to the emergency E, and terminal device information signals Sₜ (not shown) corresponding to the terminal devices 100, thereby representing the current situation at the scene of the emergency E. In the illustrated embodiment, the terminal device information signals Sₜ are provided by the terminal devices 100. Each of the terminal device information signals Sₜ includes a location of the corresponding terminal device 100. In other embodiments, the terminal device information signals Sₜ can be provided by other electronic devices capable of identifying the location of the terminal devices 100. Each of the terminal device information signals Sₜ can include other information of the corresponding terminal device 100 and the information of the user of the terminal device 100 such as the skills or the assignment of the user.

The emergency command system identifies the emergency E by the alarm signal Sₐ received from the hazard detecting apparatus 300 which is coupled to a plurality of the sensors 400. In this embodiment, the hazard detecting apparatus 300 is a fire alarm control panel. The hazard detecting apparatus 300 transmits the alarm signal Sₐ including the status information Iₛ of the actuated sensors 400 to the emergency command system when the emergency E is detected by the sensors 400. In other embodiments, the scene simulation data Dₛ can be produced merely according to the status information Iₛ of the actuated sensors 400 and the set of scene information 31, or according to the status information Iₛ of the actuated sensors 400, the set of scene information 31, and other parameters of the scene of the emergency E. In addition, the emergency command system can receive the alarm signal Sₐ directly from the sensors 400.

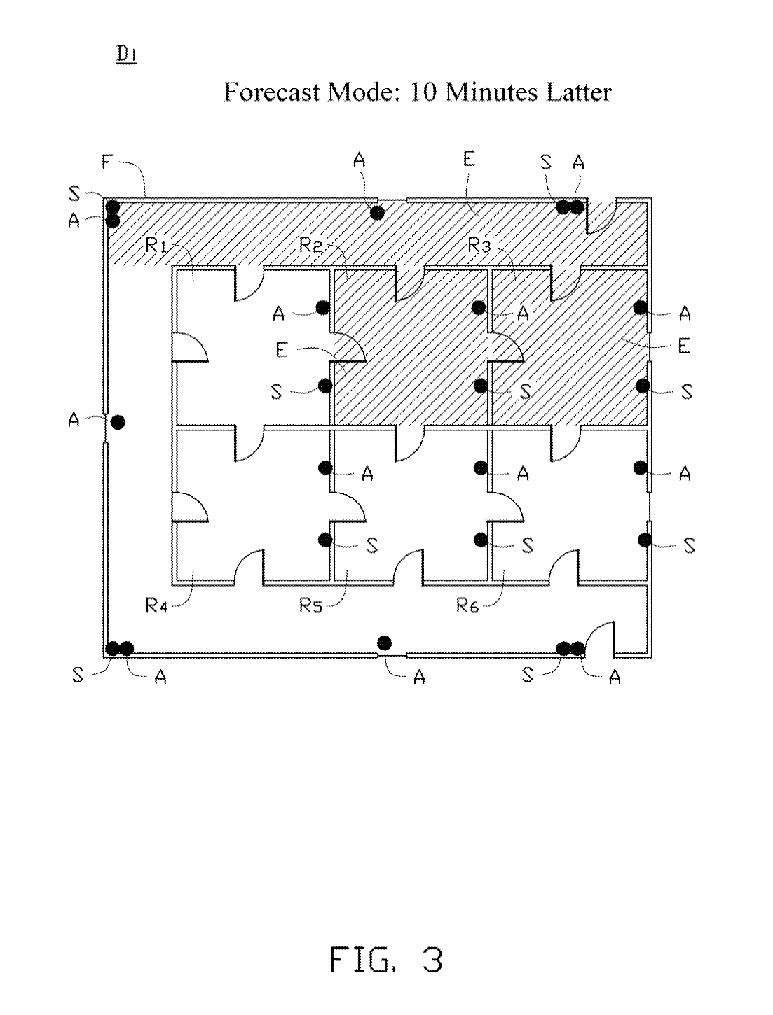

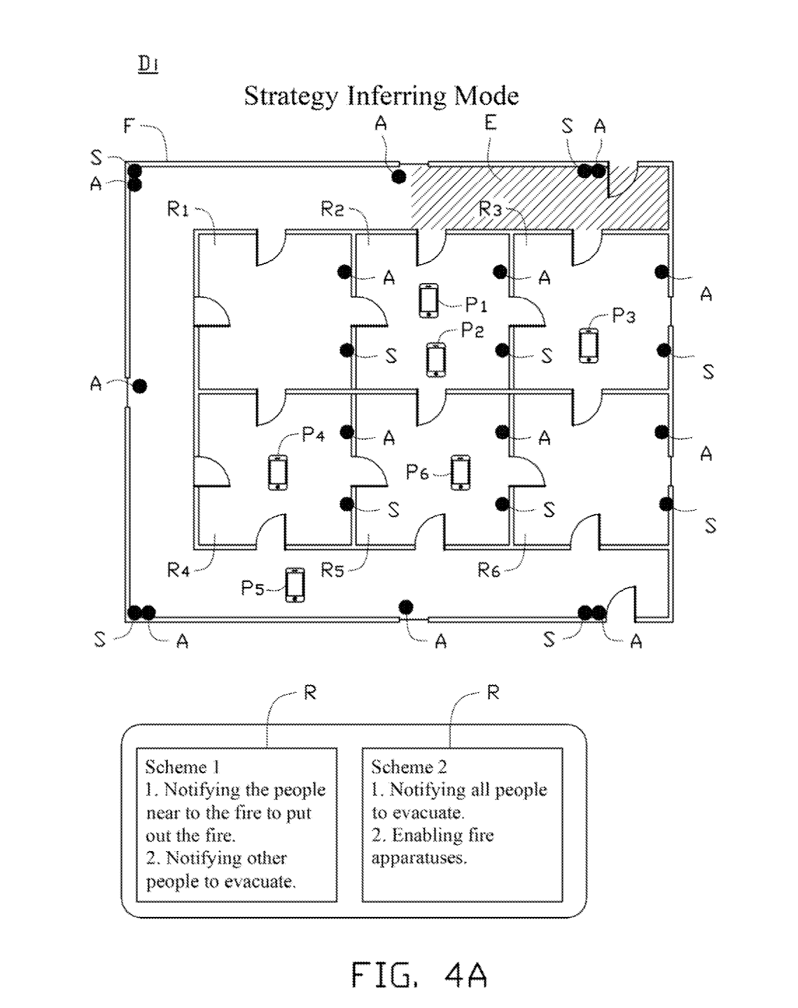

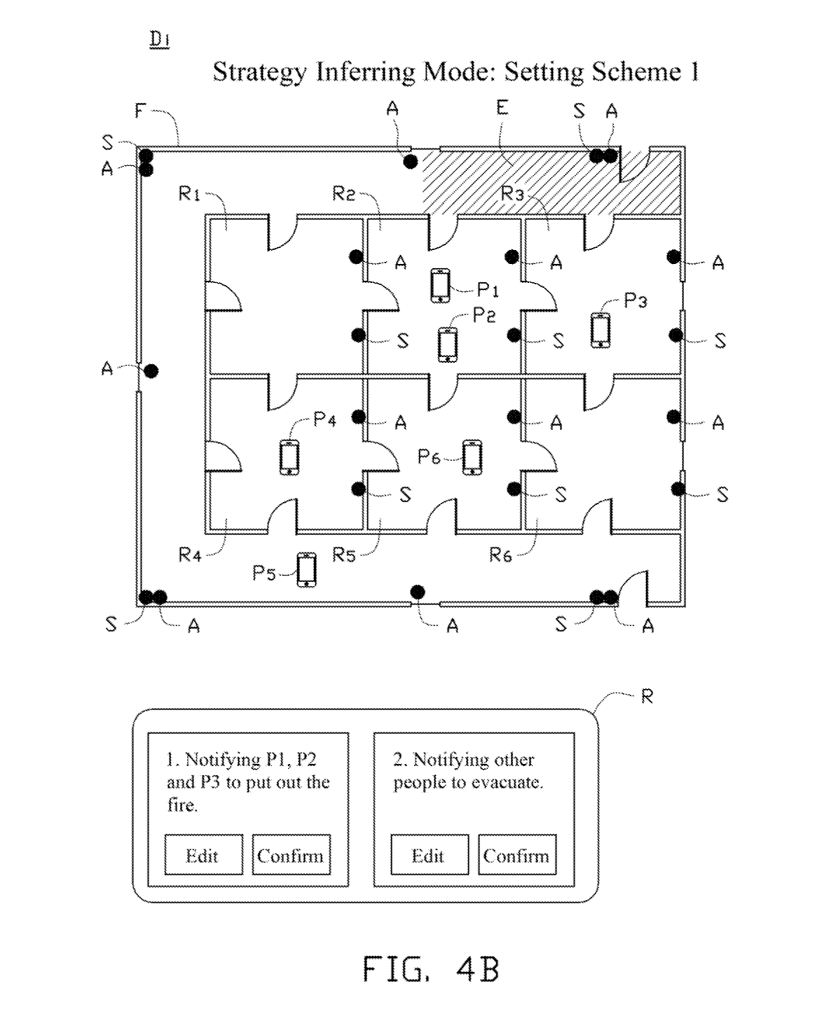

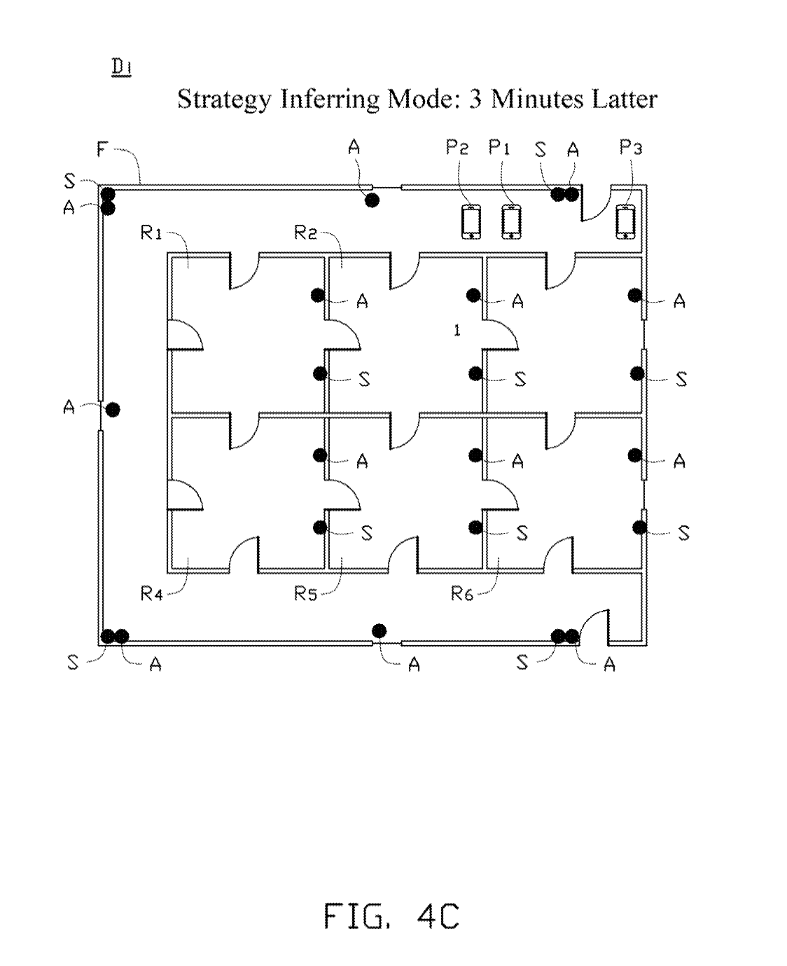

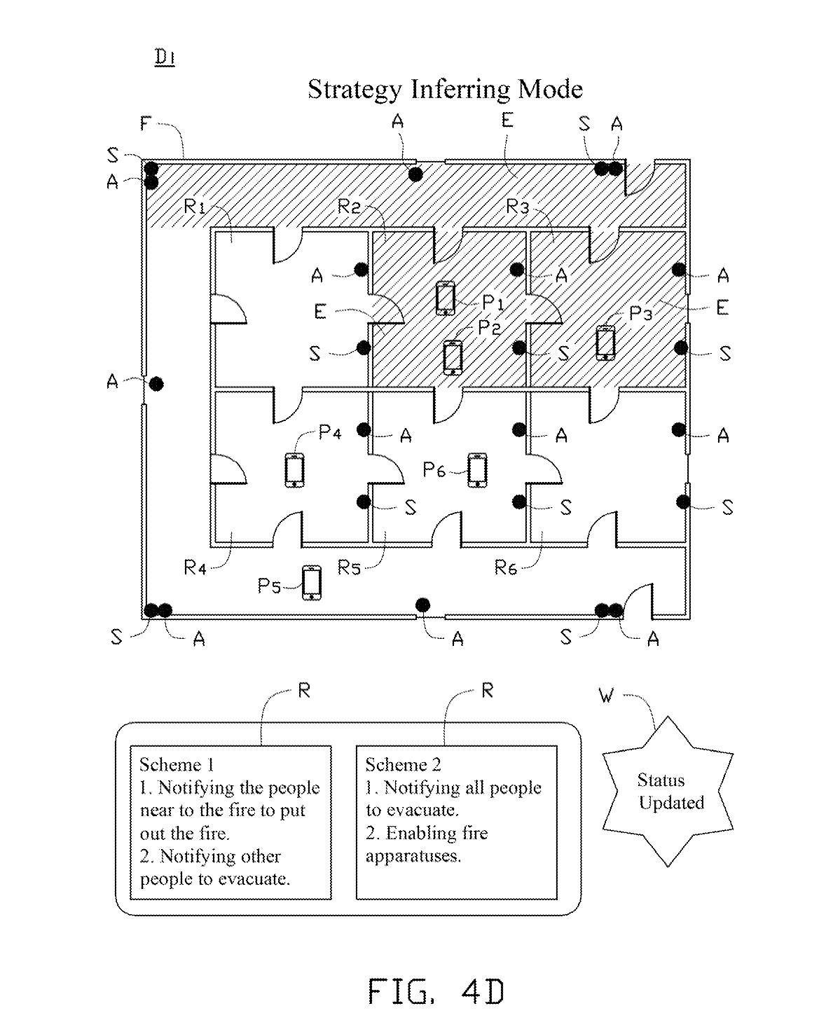

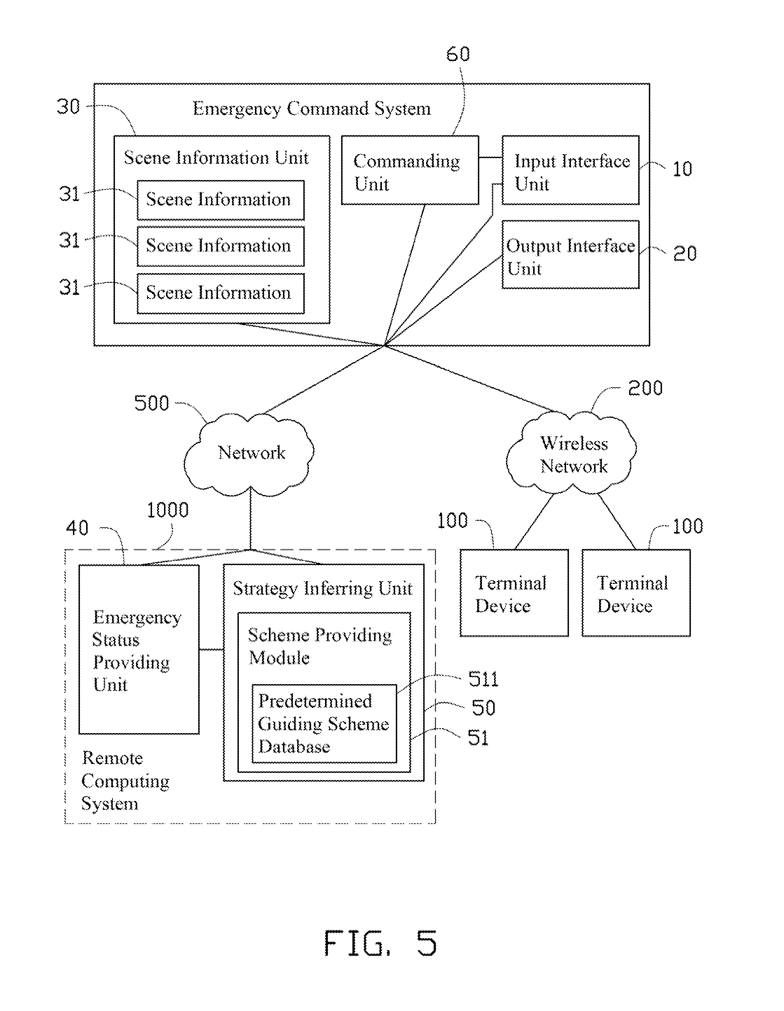

The strategy inferring unit 50 produces a strategy inference diagram Dᵢ (see FIGS. 2, 3, 4A, 4B, and 4C) corresponding to the scene of the emergency E. The strategy inference diagram Dᵢ is produced according to the scene simulation data Dₛ and/or strategy data Dₜ (not shown), wherein the strategy data Dₜ corresponds to a strategy with respect to the emergency E such as a process to put out a fire or a method of evacuation. The strategy data Dₜ is input through the input interface unit 10. The strategy inference diagram Dᵢ is displayed through the output interface unit 20. The emergency command system is selectively operated in any of three operation modes including a real time monitoring mode Mₘ (see FIG. 2), a forecast mode M_{f} (see FIG. 3), and a strategy inferring mode Mᵢ (see FIGS. 4A, 4B, and 4C). The operation mode which the emergency command system operates can be switched through the input interface unit 10. FIG. 2 is a schematic view of an embodiment of the emergency guiding system of FIG. 1 in real time monitoring mode. As shown in FIG. 2, sensor icons S and fire fighting apparatus icons A represent the sensors 400 and the fire fighting apparatuses disposed on a floor plan F, respectively, wherein the floor plan F including rooms R₁ to R₆ is a scene of the emergency E. The scope with respect to the emergency E, which is detected by the sensors 400, is marked. Portable device icons P₁ to P₆ represent the location of the terminal devices 100. In the real time monitoring mode Mₘ, the strategy inferring unit 50 produces the strategy inference diagram Dᵢ corresponding to the scene of the emergency E according to the scene simulation data Dₛ. That is, the monitoring mode Mₘ is a mode for representing the current situation at the scene of the emergency E. FIG. 3 is a schematic view of an embodiment of the emergency guiding system of FIG. 1 in forecast mode. As shown in FIG. 3, in the forecast mode M_{f}, the strategy inferring unit 50 produces the strategy inference diagram Dᵢ corresponding to a simulation of the scene of the emergency E at a future time (say 10 minutes) according to the scene simulation data Dₛ, wherein the future time can be changed according to actual demands by using the input interface unit 10. That is, the forecast mode M_{f} is a mode for representing a forecast of how events at the emergency E will unfold according to a selected plan of action.

The strategy inferring unit 50 includes a scheme providing module 51 producing recommended schemes (plan of action) R (see FIG. 4A). The recommended schemes R can be edited according to actual demands and can be set as the strategy data Dₜ through the input interface unit 10. The scheme providing module 51 updates the recommended schemes R in response to a status update signal Sᵤ (not shown) corresponding to any changes of the emergency E. Information regarding changes of the emergency E can be obtained by, for example, receipt of reports from users of any of the terminal devices 100, and/or changes of the data received from the sensors 400, wherein the status update signal Sᵤ is received from the terminal devices 100. The user can be a member of an emergency response team. In the illustrated embodiment, the scheme providing module 51 includes a predetermined guiding scheme database 511 including predetermined guiding schemes Gₚ (not shown) corresponding to the sensors 400. The predetermined guiding schemes Gₚ are guiding schemes determined in advance according to various possible scenarios of the kind of sensory data that might be received from the sensors 400 such as the location, the type, the detected parameters, and the actuation time of the sensors 400. Each of the predetermined guiding schemes Gₚ includes various sets of the status of the sensors 400 which are conditions in choosing the schemes and information to be provided to the terminal devices 100. In other embodiments, the predetermined guiding schemes Gₚ can include other information such as the fire fighting apparatuses at the scene of the emergency E to be enabled or recommended routes to reach a particular target. The scheme providing module 51 chooses at least one of the predetermined guiding schemes Gₚ as the recommended schemes R according to the status information Iₛ of the actuated sensors 400 in the alarm signal Sₐ, the set of scene information 31 in the scene information unit 30 corresponding to the emergency E, and the terminal device information signal Sₜ corresponding to the terminal devices 100. In other embodiments, the recommended scheme R can be chosen merely according to the status information Iₛ of the actuated sensors 400 and the set of scene information 31, or the status information Iₛ of the actuated sensors 400, the set of scene information 31, and other parameters. In addition, the scheme providing module 51 can determine the guiding scheme G by other methods such as using a guiding scheme determination algorithm, instead of using the predetermined guiding scheme database 511. Since the emergency command system identifies the emergency E by the alarm signal Sₐ which represents the real time conditions of the emergency E, the recommended scheme R can be produced in a dynamic manner and updated correspondingly.

FIG. 4A is a schematic view of an embodiment of the emergency guiding system of FIG. 1 in strategy inferring mode to show predetermined guiding schemes. As shown in FIG. 4A, in the strategy inferring mode Mᵢ, the scheme providing module 51 of the strategy inferring unit 50 firstly produces the recommended schemes R to be selected, wherein the recommended schemes R are selected through the input interface unit 10. In the illustrated embodiment, two recommended schemes R are provided. FIG. 4B is a schematic view of an embodiment of the emergency guiding system of FIG. 1 in strategy inferring mode to edit a predetermined guiding scheme. As shown in FIG. 4B, the selected recommended scheme R can be edited according to actual demands and can be set as the strategy data Dₜ, through the input interface unit 10. In the illustrated embodiment, two items of the selected recommended schemes R can be respectively edited. After the two items are confirmed, the selected recommended scheme R is set as the strategy data Dₜ. FIG. 4C is a schematic view of an embodiment of the emergency guiding system of FIG. 1 in strategy inferring mode to simulate the effect of a strategy. As shown in FIG. 4C, the scheme providing module 51 produces the strategy inference diagram Dᵢ corresponding to a simulation of the scene of the emergency E at a future time (say 3 minutes) according to the scene simulation data Dₛ and the strategy data Dₜ corresponding to the selected recommended schemes R, wherein the future time can be adjusted according to actual demands by using the input interface unit 10. That is, the strategy inferring mode Mᵢ is a mode for representing a forecast of the effect of the strategy corresponding to the strategy data Dₜ with respect to emergency E. In the illustrated embodiment, the emergency E is resolved 3 minutes later. FIG. 4D is a schematic view of an embodiment of the emergency guiding system of FIG. 1 in strategy inferring mode to show a warning message. As shown in FIG. 4D, the strategy inferring unit 50 produces a warning message W in response to the status update signal Sᵤ, thereby informing about the change of the status of the emergency E in strategy inferring mode Mᵢ. In addition, the strategy inferring unit 50 records the effect of the strategy corresponding to the strategy data Dₜ. If the effect of the strategy is not as successful as the simulation of the scene of the emergency E produced in the strategy inferring mode Mᵢ (see FIG. 4C), the strategy inferring unit 50 produces the warning message W, thereby informing the user of the terminal device 100 to adjust the strategy.

FIG. 5 is a block diagram of another embodiment of an emergency command system of the present disclosure. As shown in FIG. 5, the emergency status providing unit 40 and the strategy inferring unit 50 are in a remote computing system 1000 which communicates with the emergency command system E through a network 500. The emergency command system transmits the alarm signal Sₐ, the set of scene information 31 in the scene information unit 30 corresponding to the emergency E, and the strategy data Dₜ to the remote computing system 1000, and receives the strategy inference diagram Dᵢ produced through the remote computing system 1000 from the remote computing system 1000. In the illustrated embodiment, the remote computing system 1000 is a cloud computing system. In other embodiments, in addition to the emergency status providing unit 40 and the strategy inferring unit 50, the scene information unit 30 can also be in the remote computing system 1000. Correspondingly, the emergency command system merely transmits the alarm signal Sₐ and the strategy data Dₜ to the remote computing system 1000, and receives the strategy inference diagram Dᵢ from the remote computing system 1000.

The commanding unit 60 produces command signals S_{c} (not shown) according to the strategy data Dₜ in response to a control signal Sₜ (not shown) from the input interface unit 10, and transmits the command signals S_{c} to the terminal devices 100. In the illustrated embodiment, the strategy data Dₜ includes providing information such as a command to the user of the terminal devices 100 through the terminal devices 100. Correspondingly, the commanding unit 60 transmits the command signal S_{c} to the terminal device 100 to provide the information to the user of the terminal devices 100. In addition, the strategy data Dₜ can include enabling certain fire fighting apparatuses at the scene of the emergency E. Correspondingly, the commanding unit 60 transmits the command signal S_{c} to the certain fire fighting apparatuses to enable the certain fire fighting apparatuses.

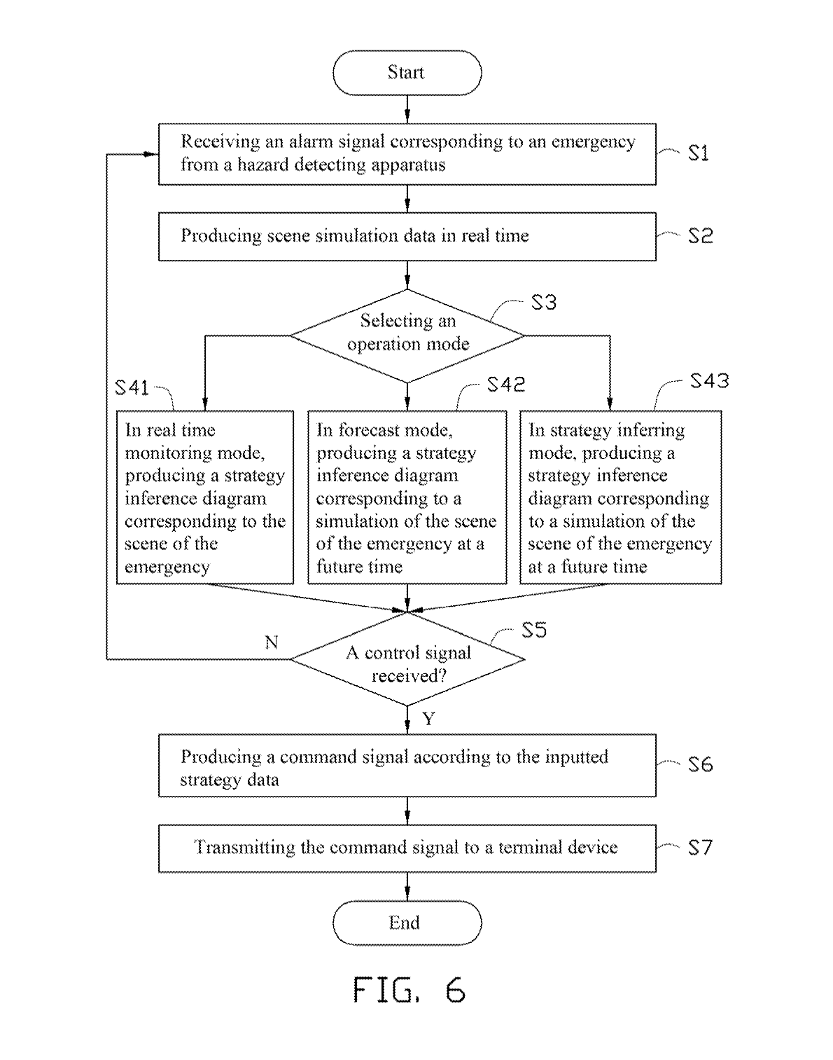

FIG. 6 is a flowchart of an embodiment of an emergency command method of the present disclosure. As shown in FIG. 6, the emergency command method of the present disclosure is as follows. Depending on the embodiment, additional steps may be added, others removed, and the ordering of the steps may be changed.

In step S1, an alarm signal corresponding to an emergency from a hazard detecting apparatus is received.

In step S2, scene simulation data is produced in real time according to the alarm signal, a set of scene information corresponding to the emergency, and a terminal device information signal corresponding to a terminal device which is a portable device such as tablet computer or smart phone. Each set of scene information includes fire fighting apparatus information including the information of the fire fighting apparatuses at the scene of the emergency such as the type, the location, and other features of the fire fighting apparatuses. In other embodiments, the scene simulation data can be produced merely according to the alarm signal and the set of scene information, or according to the alarm signal, the set of scene information, and other parameters of the scene of the emergency.

In step S3, the operation mode of the emergency command method is selected. The operation modes can be selected includes a real time monitoring mode (see FIG. 2), a forecast mode (see FIG. 3), and a strategy inferring mode (see FIGS. 4A, 4B, and 4C). The operation mode which the emergency command method operates can be switched through an input interface unit such as a keyboard, a mouse, or a touch panel. A strategy inference diagram is produced according to the scene simulation data and/or strategy data, and displayed through an output interface unit such as a display panel. The strategy data is input through the input interface unit. In step S41, when the real time monitoring mode (see FIG. 2) is selected, the strategy inference diagram corresponding to the scene of the emergency is produced according to the scene simulation data. In step S42, when the forecast mode (see FIG. 3) is selected, the strategy inference diagram corresponding to a simulation of the scene of the emergency at a future time is produced according to the scene simulation data. In step S43, when the strategy inferring mode (see FIGS. 4A, 4B, and 4C) is selected, the strategy inference diagram corresponding to a simulation of the scene of the emergency at a future time is produced according to the scene simulation data and the strategy data.

In the illustrated embodiment, a recommended scheme is produced according to the alarm signal and the set of scene information corresponding to the emergency, wherein the recommended scheme is capable of being edited and set as the strategy data through the input interface unit. The recommended scheme is updated in response to a status update signal corresponding to the change of the status of the emergency according to the alarm signal, the set of scene information in the scene information unit corresponding to the emergency, and the status update signal. Information regarding changes of the emergency can be obtained by, for example, receipt of reports from users of any of the terminal device, wherein the status update signal is received from the terminal device. A warning message (see FIG. 4D) can be produced in response to the status update signal. In addition, the warning message can also be produced when the effect of the strategy corresponding to the strategy data is not as successful as the simulation of the scene of the emergency produced in the strategy inferring mode (see FIG. 4C).

In step S5, reception of a control signal is determined. If a control signal is received, step S6 is implemented; otherwise, step S1 is implemented. The control signal is received from the input interface unit.

In step S6, a command signal is produced according to the strategy data.

In step S7, the command signal is transmitted to a terminal device. In the illustrated embodiment, the strategy data includes providing information through the terminal device, and step S7 transmits the command signal to the terminal device to provide the information. In other embodiments, the strategy data can include enabling at least a fire fighting apparatus, and step S7 transmits the command signal to the fire fighting apparatus to enable the fire fighting apparatus.

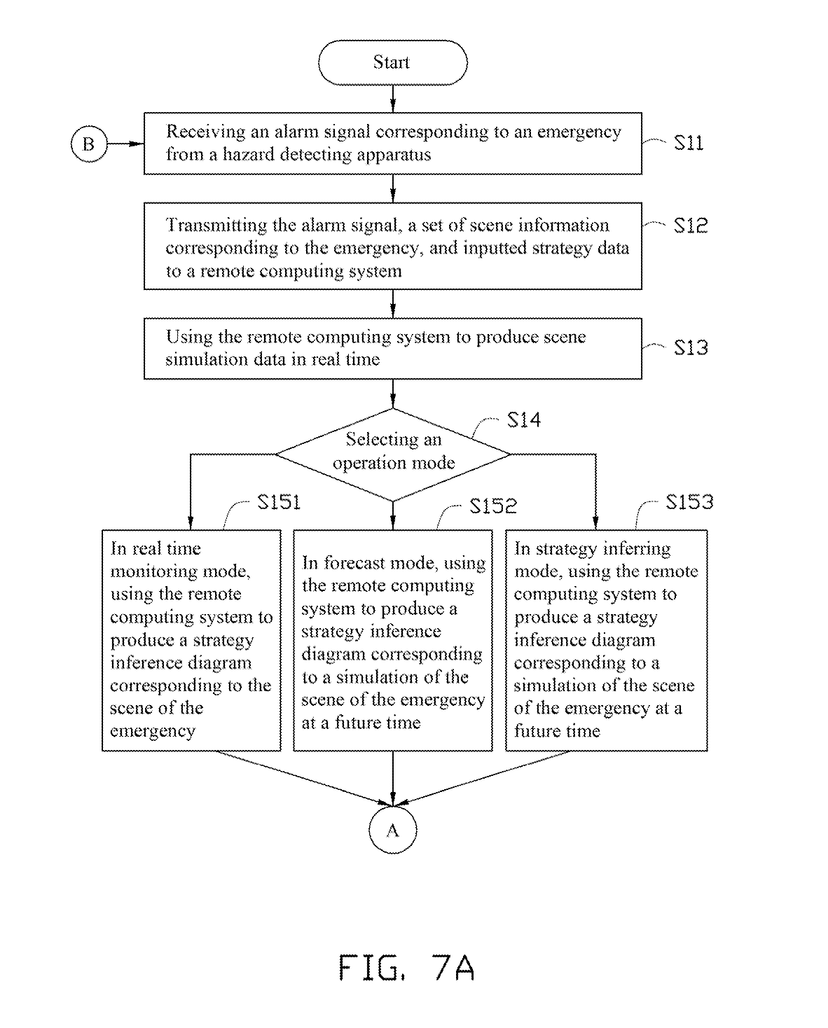

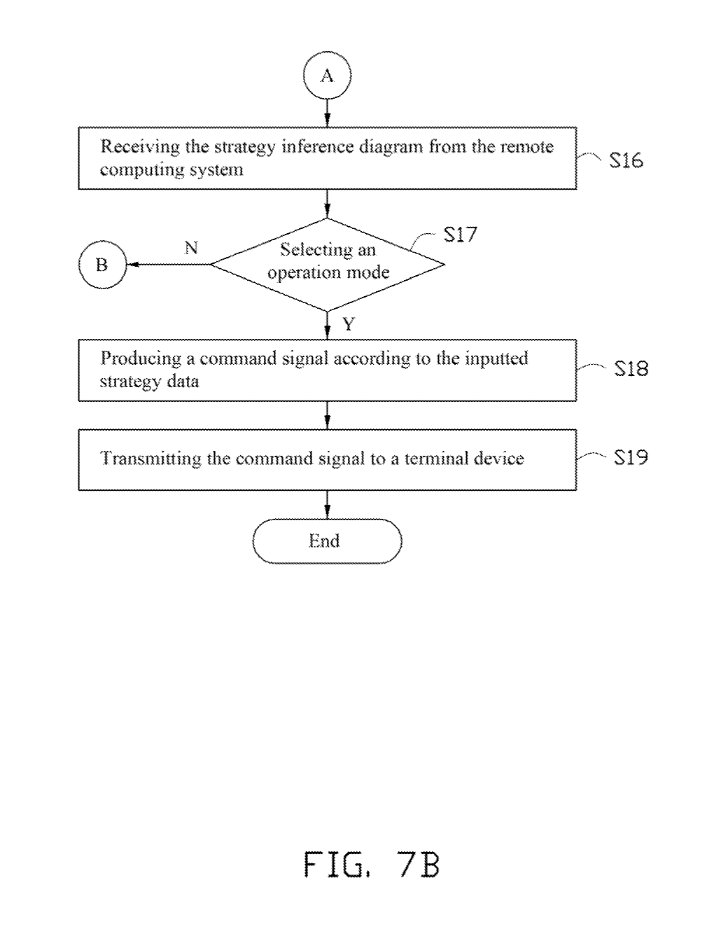

In the illustrated embodiment, the steps S1 to S7 are performed by an electronic device such as personal computer or notebook computer. In other embodiments, the step of producing the scene simulation data (step S2) and the step of producing the strategy inference diagram (step S3) can be performed by a remote computing system communicated through a network. FIG. 7A/7B is a flowchart of another embodiment of an emergency command method of the present disclosure. As shown in FIG. 7A/7B, the emergency command method of the present disclosure is as follows. Depending on the embodiment, additional steps may be added, others removed, and the ordering of the steps may be changed.

In step S11, an alarm signal corresponding to an emergency from a hazard detecting apparatus is received.

In step S12, the alarm signal, a set of scene information corresponding to the emergency, and strategy data are transmitted to a remote computing system. In the illustrated embodiment, the remote computing system is a cloud computing system. In other embodiments, the set of scene information can be provided by the remote computing system. Correspondingly, merely the alarm signal and the strategy data are transmitted to the remote computing system.

In step S13, scene simulation data is produced by the remote computing system in real time according to the alarm signal, the set of scene information corresponding to the emergency, and a terminal device information signal corresponding to a terminal device.

In step S14, the operation mode of the emergency command method is selected. In step S151, when the real time monitoring mode is selected, the strategy inference diagram corresponding to the scene of the emergency is produced by the remote computing system according to the scene simulation data. In step S152, when the forecast mode is selected, the strategy inference diagram corresponding to a simulation of the scene of the emergency at a future time is produced by the remote computing system according to the scene simulation data. In step S153, when the strategy inferring mode is selected, the strategy inference diagram corresponding to a simulation of the scene of the emergency at a future time is produced by the remote computing system according to the scene simulation data and the strategy data.

In step S16, the strategy inference diagram is received from the remote computing system.

In step S17, reception of a control signal is determined. If a control signal is received, step S18 is implemented; otherwise, step S1 is implemented.

In step S18, a command signal is produced according to the strategy data.

In step S19, the command signal is transmitted to a terminal device.

In comparison with conventional emergency command systems, the emergency command system and the emergency command method are capable of providing adequate information of the scene of an emergency, such that an emergency responder can command according to the current situation of the scene of the emergency. In addition, the effects of the emergency responder's decision can be predicted in advance and recorded in real time by simply switching the operation mode. Consequently, the strategy with respect to the emergency can be adjusted appropriately in a short time.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An emergency command system, comprising:
an input interface unit;
a scene information unit including at least one set of scene information;
an emergency status providing unit receiving an alarm signal corresponding to an emergency from a hazard detecting apparatus, wherein the emergency status providing unit produces scene simulation data in real time according to the alarm signal and the set of scene information in the scene information unit corresponding to the emergency;
a strategy inferring unit producing a strategy inference diagram;
an output interface unit displaying the strategy inference diagram; and
a commanding unit transmitting at least a command signal to at least a terminal device, wherein the commanding unit produces the command signal according to the strategy data in response to a control signal from the input interface unit;
wherein the emergency command system is selectively operated in a real time monitoring mode, a forecast mode, and a strategy inferring mode by using the input interface unit; wherein in the real time monitoring mode, the strategy inferring unit produces the strategy inference diagram corresponding to the scene of the emergency according to the scene simulation data; in the forecast mode, the strategy inferring unit produces the strategy inference diagram corresponding to a simulation of the scene of the emergency at a future time according to the scene simulation data; in the strategy inferring mode, the strategy inferring unit produces the strategy inference diagram corresponding to a simulation of the scene of the emergency at a future time according to the scene simulation data and strategy data input through the input interface unit.

2. The system of claim 1, wherein the strategy inferring unit records the effect of the strategy corresponding to the strategy data, and produces a warning message when the effect of the strategy is not as successful as the simulation of the scene of the emergency produced in the strategy inferring mode, the output interface unit displays the warning message.

3. The system of claim 1, wherein each set of scene information of scene information unit includes a fire fighting apparatus information.

4. The system of claim 1, wherein the emergency status providing unit produces the scene simulation data further according to a terminal device information signal corresponding to the terminal device.

5. The system of claim 1, wherein the strategy inferring unit includes a scheme providing module producing at least a recommended scheme capable of being edited and set as the strategy data through the input interface unit, the recommended scheme is produced according to the alarm signal and the set of scene information in the scene information unit corresponding to the emergency.

6. The system of claim 5, wherein the scheme providing module updates the recommended scheme in response to a status update signal corresponding to the change of the status of the emergency.

7. The system of claim 5, wherein the emergency guiding server identifies the emergency by an alarm signal received from a hazard detecting apparatus coupled to a plurality of sensors, the hazard detecting apparatus transmits the alarm signal including status information of the actuated sensors to the emergency guiding server in response to detecting the emergency through the sensors, wherein the scheme providing module includes a predetermined guiding scheme database including a plurality of predetermined guiding schemes corresponding to the sensors, the scheme providing module chooses at least one of the predetermined guiding schemes as the recommended scheme according to the status information of the actuated sensors in the alarm signal and the set of scene information.

8. The system of claim 1, wherein the emergency status providing unit and the strategy inferring unit are in a remote computing system communicating with the emergency command system through a network, the emergency command system transmits the alarm signal, the set of scene information in the scene information unit corresponding to the emergency, and the strategy data to the remote computing system, and receives the strategy inference diagram from the remote computing system.

9. The system of claim 1, wherein the strategy data includes providing information through the terminal device, the commanding unit transmits the command signal to the terminal device to provide the information.

10. The system of claim 1, wherein the strategy data includes enabling at least a fire fighting apparatus, the commanding unit transmits the command signal to the fire fighting apparatus to enable the fire fighting apparatus.

11. An emergency command method, comprising:
receiving an alarm signal corresponding to an emergency from a hazard detecting apparatus;
producing scene simulation data in real time according to the alarm signal and a set of scene information corresponding to the emergency;
producing a strategy inference diagram corresponding to the scene of the emergency according to the scene simulation data when in a real time monitoring mode;
producing the strategy inference diagram corresponding to a simulation of the scene of the emergency at a future time according to the scene simulation data when in a forecast mode;
producing the strategy inference diagram corresponding to a simulation of the scene of the emergency at a future time according to the scene simulation data and strategy data when in a strategy inferring mode;
producing a command signal in response to an inputted control signal according to the strategy data; and
transmitting the command signal to a terminal device.

12. The method of claim 11, further comprising producing a warning message when the effect of the strategy corresponding to the strategy data is not as successful as the simulation of the scene of the emergency produced in the strategy inferring mode.

13. The method of claim 11, wherein each set of scene information includes a fire fighting apparatus information.

14. The method of claim 11, wherein the scene simulation data is produced further according to a terminal device information signal corresponding to the terminal device.

15. The method of claim 11, further comprising producing at least a recommended scheme capable of being edited and set as the strategy data, wherein the recommended scheme is produced according to the alarm signal and the set of scene information corresponding to the emergency.

16. The method of claim 15, further comprising updating the recommended scheme in response to a status update signal corresponding to the change of the status of the emergency according to the alarm signal, the set of scene information in the scene information unit corresponding to the emergency, and the status update signal.

17. The method of claim 15, wherein in the step of receiving the alarm signal, the alarm signal is received from a hazard detecting apparatus coupled to a plurality of sensors, the hazard detecting apparatus transmits the alarm signal including status information of the actuated sensors in response to detecting the emergency through the sensors, wherein the step of producing the recommended scheme includes choosing the recommended scheme from a plurality of predetermined guiding schemes corresponding to the sensors in a predetermined guiding scheme database.

18. The method of claim 11, wherein the steps of producing the scene simulation data and producing the strategy inference diagram are performed by a remote computing system communicated through a network, the method further comprises transmitting the alarm signal, the set of scene information corresponding to the emergency, and the strategy data to the remote computing system, and receiving the strategy inference diagram from the remote computing system.

19. The method of claim 11, wherein the strategy data includes providing information through the terminal device, wherein the step of transmitting the command signal includes transmitting the command signal to the terminal device to provide the information.

20. The method of claim 11, the strategy data includes enabling at least a fire fighting apparatus, wherein the step of transmitting the command signal includes transmitting the command signal to the fire fighting apparatus to enable the fire fighting apparatus.
